(19) United States
(12) Patent Application Publication
(10) Pub. No.: US 2015/0020362 A1
(43) Pub. Date: Jan. 22, 2015

(54) Method For Displaying Advertising Devices

(71) Applicant: Robert W. Irwin, Mono Twp (CA)

(72) Inventor: Robert W. Irwin, Mono Twp (CA)

(21) Appl. No.: 13/947,506

(22) Filed: Jul. 22, 2013

(51) Int. Cl. G09F 17/00

(52) U.S. Cl. CPC G09F 17/00; G09F 2017/0066
USPC 29/428

(57) ABSTRACT

A method allowing easy erection and removal of advertising devices such as flags, banners or similar message conveying means. System consists of a sleeve or receiving apparatus to accept adaptor which is attached to said advertising device. Receiver may be used inground or above ground. A driving rod to mechanically insert sleeve into ground. A threaded extraction device. A cap to protect sleeve from external contaminants such as precipitation or grass clippings. A base to which receiver attaches for above ground applications. An adaptor attached to advertising device which inserts into receiving sleeve secured by natural forces with no mechanical means allowing for freedom of motion and rotation up to 360 degrees without constraint. An extension to elevate advertising devices overcoming obstacles such as flowerbeds, hedges, fences or grow.

### FIELD OF THE INVENTION

This invention relates to temporary signage most particularly being banners, advertising flags and informational signs intended to be readily erected, removed and or relocated.

### BACKGROUND OF THE INVENTION

Advertising flags, banners and readily relocate able signage are becoming very popular. The advantage of this type of advertising is its relatively inexpensive costs as well as the benefit of having it where you want it, when you want it. Be it in front of a business promoting their products or services, on a golf course announcing tournament sponsors or at a festival promoting events, entertainment or dining establishments, the purpose is to convey direction and create public awareness.

Due to the recent advancements in the digital printing industry, materials such as fabrics, vinyls and specialized papers are now common place as advertising media both indoors and outdoors. Therefore the demand for temporary signage is in a pattern of steady and rapid growth.

Most temporary flag, banner or sign systems rely on the media being suspended from one or more upright poles or columns. These poles or columns are themselves commonly driven beneath the earths surface or may be slid over a rod or dowel inserted into the ground. The rod or dowel protrudes upward from the earth and may be a safety hazard once the pole or column has been removed.

This invention offers an alternative to the somewhat unsightly and even potentially dangerous rod or dowel protruding from the earth's surface. It also offers increased speed and simplicity when erecting and removing said advertising devices.

It is an object of the present invention to provide a fast and simple method for installing and removing advertising devices.

It is a further object of the present invention to make advertising devices easy to relocate in order to receive the optimum results desired.

It is a further object of the present invention to make the display of such advertising devices safer to the general public.

It is a further object of the present invention to provide a more safe and desirable system for landscape maintenance workers and their equipment.

### SUMMARY OF THE INVENTION

A system or method allowing for easy erection and removal of advertising devices such as flags, banners or similar message conveying means comprising.

A receiving cylinder which may be used in ground or above ground.

A metal rod used to drive receiving cylinder into the earth.

A stand to which receiving cylinder attaches for above ground applications.

An extension to elevate advertising devices above obstacles such as plants, fences or snow.

An adaptor which is attached to advertising device and is compatible with receiving cylinder.

A cap to protect receiving cylinder from external contaminants such as precipitation or grass clippings.

An extraction device to remove receiving cylinder from the earth.

### DESCRIPTION OF DRAWINGS

Preferred embodiments of the invention are described below with reference to the accompanying drawings in which:

FIG. 1 is a perspective view of the elements pertaining to the described invention.

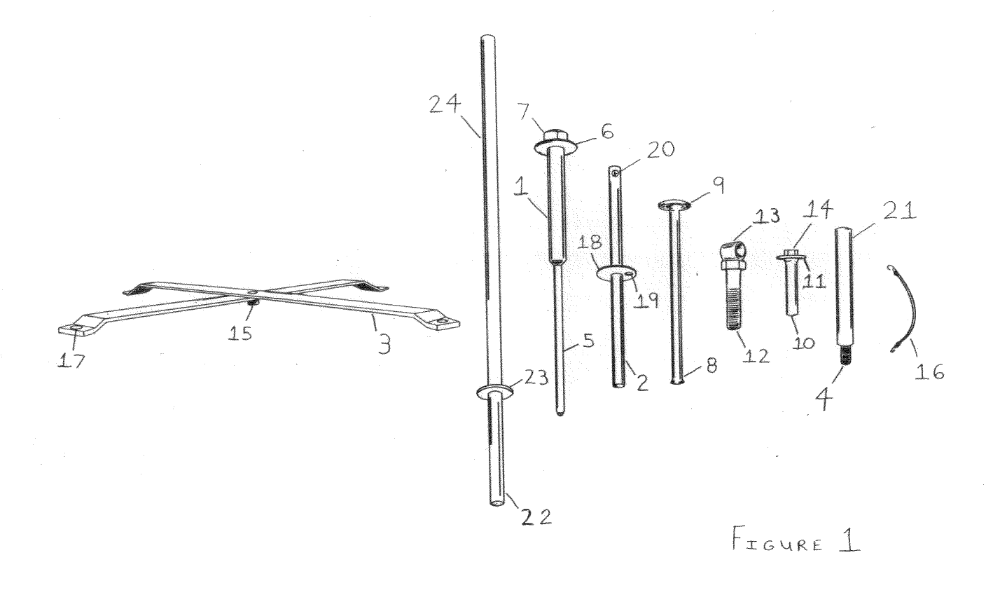

FIG. 2 is a perspective view of the described invention illustrating its purpose when displaying a flag

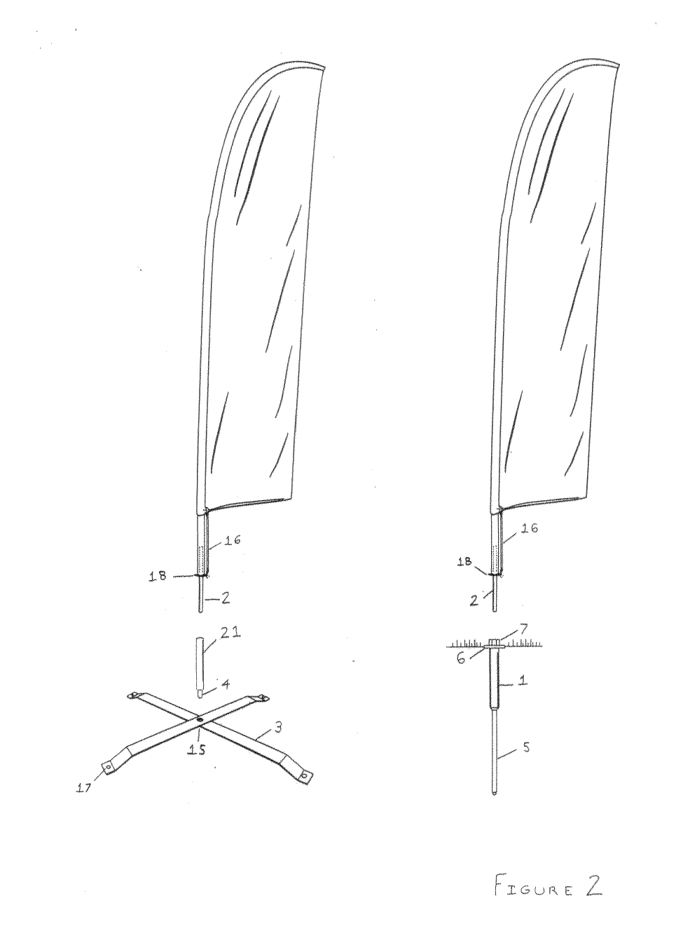

FIG. 3 is a perspective view of the described invention illustrating its purpose when displaying a flag utilizing the extension

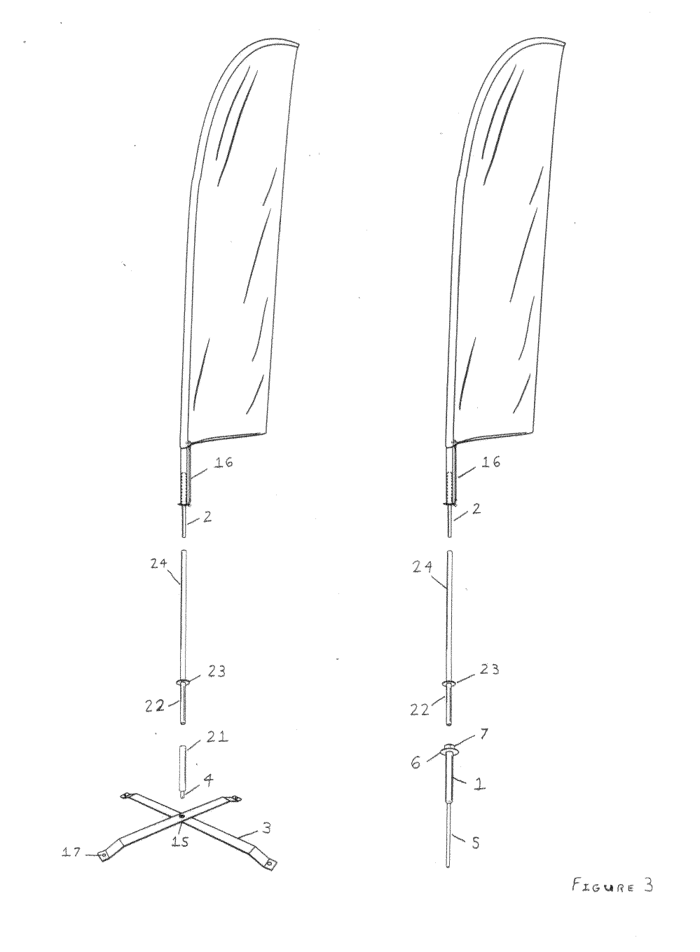

FIG. 4 is a perspective view of the described invention illustrating its purpose when displaying a banner

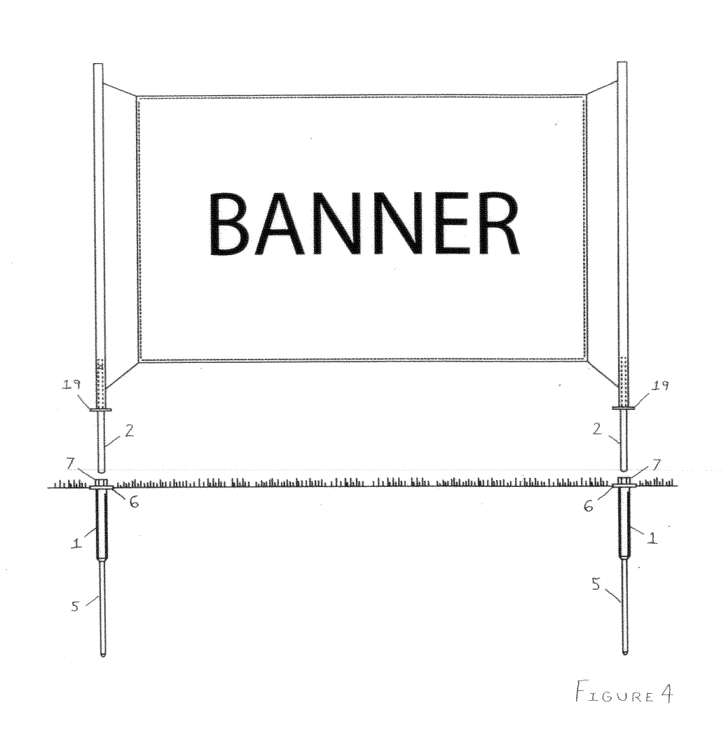

FIG. 5 is a perspective view of the described invention illustrating its purpose when displaying other types of informational or directional signage

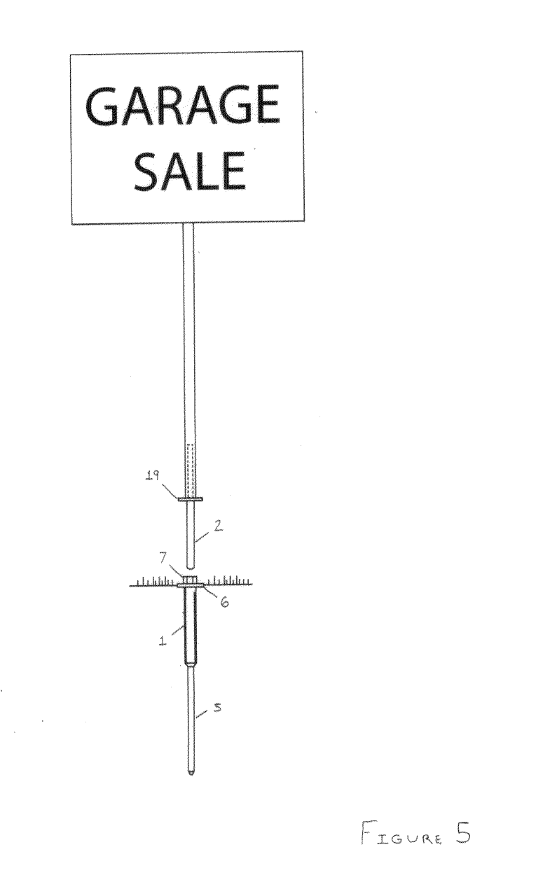

The core of the invention consists of a tubular or cylindrical sleeve 1,21 in which an adaptor 2 is inserted. The adaptor 2 is secured in the sleeve 1,21 by gravitational means and is releasable with upward force or pull. Adaptor 2 is attached to a pole, column or advertising media via mechanical means such as a threaded fastener, fusion or tie down using materials such as elastic, rope, chain or adjustable straps 16.

One method is that the cylindrical sleeve 21 is attached to an above ground stand 3 which may be suitable for indoors or outdoor use. The stand 3 receives the sleeve 21 via a mechanical thread 4. The stand 3 may be comprised of one piece or more commonly two or more components overlapping to create an X pattern offering ease of transport and increased stability. The stand 3 or one component of the stand 3 may support an internal threaded portion 15 to receive external thread 4 of sleeve 21. The stand 3 may also support a fastening system designed to anchor the stand 3 to the surface on which it rests. This may be accomplished by using a weighted device on the surface of the stand 3 or by anchoring the stand 3 by mechanical means such as a nail like fastener, bolts, pins or screws through anchor holes 17.

Another method which is primarily for use in an outdoor application is where the cylindrical sleeve 1 is inserted into the earth's surface to the point of being flush with the earth's surface or slightly below. The sleeve 1 may have a solid metal rod 5 attached to the hollow cylindrical sleeve 1 thus creating a bottom or end to the sleeve 1. Nearing the top portion of the sleeve 1 is a collar 6 which is attached to the outside of the cylindrical sleeve 1 creating a stopping point when driven into the earth. Atop the collar 6 is an internally threaded portion 7 which allows for the easy removal of the sleeve 1 from the earth.

The sleeve 1 is inserted into the earth using force such as a hammer which delivers its blow to a metal rod 8 having a head 9 with a size preferably twice or more in diameter than the rod 8 itself. The rod 8 is slightly longer than the hollow section of the sleeve 1 and imparts its force on the bottom surface 5 of the hollow portion of the sleeve 1. This protects the threaded portion 7 from the impact of the hammer avoiding any potential damage to the threaded portion 7.

With the collar 6 flush or slightly below the earth's surface the benefits is that there is no longer the unsightly rod or dowel protruding from the ground and there is no longer a safety hazard to children, pets or equipment such as a lawnmowers and ground maintenance equipment.

Another method is where the extension 22 is inserted into cylindrical sleeve 1,21 until coming to rest on the underside of the collar 23 with the hollow portion 24 extending upward allowing for the adaptor 2 to be inserted into hollow portion 24 hereby elevating the advertising device from the ground or stand overcoming obstacles such as flowerbeds, bushes, fences or snow also creating attraction from a greater distance through the additional height.

Another important component to this system is the cap which is placed into the threaded portion 7 of the sleeve 1, or resting atop of sleeve 21 when not in use supporting the advertising device.

The cap is a metal rod 10 slightly shorter than the hollow portion of the sleeve 1, 21 with a head 11 preferably larger in diameter than the threaded portion 7. This cap is secured into the sleeve 1, 21 by means of gravity using no mechanical fasteners. It is simply removed by an upward force or pulling action. The force required is more than caused by the upward draft created by lawn cutting equipment. The cap keeps the sleeve 1, 21 free of contaminants such as lawn clippings, loose dirt and precipitation which may cause the sleeve 1,21 to fill with ice or snow. The cap may also have threaded portion 14 attached to the head 11 allowing an upward attachment such as a threaded rod or wooden dowel making the sleeve 1,21 easier to locate should it become covered with fallen leaves or snow.

The removal of the sleeve 1 from the earth is accomplished using an extractor tee. Extractor tee comprises of an externally threaded metal rod 12 with a hollow cylinder 13 affixed to one end. The concept is to turn the threaded rod 12 into the internal threads 7 located atop of the collar 6. By inserting the metal rod 8 throughout the hollow cylinder 13 of the extractor tee the sleeve 1 will simply be extracted from the earth's surface by applying an upward force or pulling motion.

The adaptor 2 which inserts into the sleeve 1, 21, 24 is a solid or hollow rod cylinder in shape to which a pole, column or advertising media is attached. A collar 18 is attached to the outside of the adaptor 2 which will prevent the adaptor 2 from coming in contact with the bottom of the sleeve 1, 21 when inserted. The collar 18 may have a hold 19 in order to secure the advertising media pole or column with appropriate fastener 16. The adaptor 2 may also have a hole 20 allowing attachment to a pole or column. The collar 18 will rest on the top of the threaded portion 7 or atop of sleeve 21, 24 and will sit freely to allow for rotation 360 degrees without constraint. The adaptor 2 is attached to a pole, column or advertising media via mechanical means such as a threaded fastener, fusion or tie down using materials such as elastic, rope, chain or adjustable straps 16. Adaptor 2 may also be attached to pole or column via gravitational forces requiring no mechanical fasteners.

It is intended that the above description by interpreted in a illustrative rather than a restricted sense. Variations to the features described above may be apparent to those skilled in such structures without departing from the spirit and scope of the invention as defined by the claims set out below.

The embodiments of the invention in which an exclusive property or privilege are claimed are defined as follows:

1. A method of installing and removing advertising devices such as flags, banners, or similar message conveying means following the steps of:
driving receiving cylinder beneath the earth's surface using a driving rod longer than the hollow portion of the receiving cylinder
inserting an adaptor which sits freely atop of receiving cylinder
connecting adaptor to advertising media, pole or column
upon removing adaptor from receiving cylinder inserting a cap which rests freely atop of cylinder thereby restricting contaminants such as dirt and precipitation from entering cylinder.
Removing cylinder from earth's surface using an extractor tee by turning extractor tee into threaded portion of receiving cylinder and inserting driving rod through hollow portion of extractor tee thus creating a handle by which cylinder is removed from the earth with an upward pulling force

2. A method as claimed in claim 1 wherein the driving rod is comprised of a solid or hollow cylindrical rod longer than the hollow portion of the receiving cylinder and lesser in diameter than the inside diameter of the receiving cylinder having a head attached to one end of the rod preferably larger in diameter than the threaded portion of the receiving cylinder.

3. A method as claimed in claim 1 wherein receiving cylinder is comprised of a threaded portion nearing top of hollow cylinder allowing for removal of cylinder from beneath the earth's surface.

4. A method as claimed in claim 3 wherein receiving cylinder is comprised of a solid rod attached to one end of the hollow cylinder thereby creating a bottom to the cylinder.

5. A method as claimed in claim 3 wherein receiving cylinder has a collar broader in diameter than the cylinder and attached to the circumference of the cylinder nearing end opposite to solid rod and next to threaded portion thereby creating a stopping point acting as a means of limiting depth that the cylinder is inserted beneath the earth's surface.

6. A method as claimed in claim 1 wherein an adaptor comprised of a solid or hollow cylindrical rod is smaller in diameter than the inside diameter of the receiving cylinder and has a collar nearing the mid portion of the adaptor which is preferably larger in diameter than the threaded portion of said receiving cylinder thereby limiting the depth in which the adaptor may be inserted into said receiving cylinder.

7. A method as claimed in claim 6 wherein the collar located near mid portion of the adaptor has a hole nearing outer portion allowing for the attachment of advertising media, pole or column with appropriate fastener such as elastic, rope, chain or adjustable straps.

8. A method as claimed in claim 6 and wherein adaptor has a bored hole nearing one end to allow attachment of pole or column to which advertising media is attached.

9. A method as claimed in claim 1 and wherein advertising pole or column may be connected to adaptor via gravitational forces requiring no mechanical fastener.

10. A method as claimed in claim 1 wherein a cap is comprised of a solid or hollow rod which is shorter than the hollow portion of the receiving cylinder and lesser in diameter than the inside diameter of the receiving cylinder having a head attached to one end of the rod preferably larger in diameter than the threaded portion of receiving cylinder and a threaded portion atop of the head allowing for an attachment such as a threaded rod thereby making sleeve easier to locate in fallen leaves or snow covered ground.

11. A method as claimed in claim 1 wherein an extractor tee is comprised of an externally threaded rod having a hollow cylindrical portion attached to one end resting 90 degrees to that of the threaded portion.

12. A method as claimed in claim 11 and wherein the hollow portion has an inside diameter larger than the diameter of the driving rod allowing driving rod to be utilized as the handle in the extractor tee.

13. A method of installing and removing advertising devices such as flags, banners, or similar message conveying means following the steps of:
driving receiving cylinder beneath the earth's surface using a driving rod longer than the hollow portion of the receiving cylinder.
inserting an extension into receiving cylinder to elevate advertising device overcoming such obstacles such as flowerbeds, hedges, fences or snow
inserting an adaptor which sits freely atop of receiving portion of extension
connecting adaptor to advertising media, pole or column
inserting a cap which rests freely atop of receiving cylinder of extension thereby restricting contaminants such as dirt and precipitation from entering cylinder or extension after adaptor is removed.
Removing cylinder from earth's surface using an extractor tee by turning extractor tee into threaded portion of receiving cylinder and inserted driving rod through hollow portion of extractor tee thus creating a handle by which cylinder is removed from the earth with an upward pulling force

14. A method as claimed in claim 13 where the driving rod is comprised of a solid or hollow cylindrical rod longer than the hollow portion of the receiving cylinder and lesser in diameter than the inside diameter of the receiving cylinder having a head attached to one end of the rod preferably larger in diameter than the threaded portion of the receiving cylinder.

15. A method as claimed in claim 13 wherein receiving cylinder is comprised of a threaded portion nearing top of hollow cylinder allowing for removal of cylinder from beneath the earth's surface.

16. A method as claimed in claim 13 and wherein receiving cylinder is comprised of a solid rod attached to one end of the hollow cylinder thereby creating a bottom to the cylinder.

17. A method as claimed in claim 15 wherein receiving cylinder has a collar broader in diameter than the receiving cylinder and attached to the circumference of the cylinder nearing end opposite to solid rod and next to threaded portion thereby creating a stopping point acting as a means of limiting depth that the cylinder is inserted beneath the earth's surface.

18. A method as claimed in claim 13 wherein an extension is comprised of a hollow cylindrical rod of the same inside diameter as receiving cylinder having a solid or hollow rod attached to one end being of slightly lesser outside diameter than the inside diameter of said receiving cylinder and collar preferably larger in diameter than that threaded portion of said receiving cylinder is attached to circumference of portion of extension having smaller diameter thereby limiting the depth the extension may be inserted into the receiving cylinder.

19. A method as claimed in claim 13 wherein an adaptor comprised of a solid or hollow cylindrical rod is smaller in diameter than the inside diameter of the receiving portion of the extension and has a collar nearing the mid portion of the adaptor which is preferably larger in diameter than the receiving portion of the extension thereby limiting the depth in which the adaptor may be inserted into the receiving portion of the extension.

20. A method as claimed in claim 19 wherein the collar located near mid portion of the adaptor has a hole nearing outer portion allowing for the attachment of advertising media, pole or column with appropriate fastener such as elastic, rope, chain or adjustable straps.

21. A method as claimed in claim 19 and wherein adaptor has a bored hole nearing one end to allow attachment of pole or column to which advertising media is attached.

22. A method as claimed in claim 13 and wherein advertising media pole or column may be connected to adaptor via gravitational forces requiring no mechanical fastener.

23. A method as claimed in claim 1 wherein a cap is comprised of a solid or hollow rod which is shorter than the hollow portion of the receiving cylinder and lesser in diameter than the inside diameter of the receiving cylinder having a head attached to one end of the rod preferably larger in diameter than the threaded portion of receiving cylinder and a threaded portion atop of the head allowing for an attachment such as a threaded rod thereby making sleeve easier to locate in fallen leaves or snow covered ground.

24. A method as claimed in claim 13 wherein an extractor tee is comprised of an externally threaded rod having a hollow cylindrical portion attached to one end resting 90 degrees to that of the threaded portion.

25. A method as claimed in claim 24 and wherein hollow portion has an inside diameter larger than the diameter of driving rod allowing driving rod to be utilized as the handle in the extractor tee.

26. A method of installing and removing advertising devices such as flags, banners, or similar message conveying means following the steps of:
securing receiving cylinder into stand via mechanical thread
inserting an adaptor which sits freely atop of receiving cylinder
connecting adaptor to advertising media, pole or column
inserting a cap which rests freely atop of cylinder thereby restricting contaminants such as dirt and precipitation from entering cylinder after adaptor is removed

27. A method as claimed in claim 26 wherein the receiving cylinder is comprised of a hollow cylinder having a threaded portion at one end which is secured to a stand via mechanical thread

28. A method as claimed in claim 26 wherein an adaptor comprised of a solid or hollow cylindrical rod is smaller in diameter than the inside diameter of the receiving cylinder and has a collar nearing the mid portion of the adaptor which is preferably larger in diameter than the said receiving cylinder thereby limiting the depth in which the adaptor may be inserted into said receiving cylinder.

29. A method as claimed in claim 28 and wherein the collar located near mid portion of the adaptor has a hole nearing outer portion allowing for the attachment of advertising media, pole or column with appropriate fastener such as elastic, rope, chain or adjustable straps.

30. A method as claimed in claim 26 and whereas a sleeved flag is pulled over the pole and the flag is attached to the adaptor whereby the adaptor keeps the flag from releasing from the top of the pole and in turn the flag prevents the adaptor from releasing from the bottom of the pole which will create a bend at the top of the pole holding the flag open to view at all times if desired.

31. A method as claimed in claim 26 and wherein adaptor has a bored hole nearing one end to allow attachment of pole or column to which advertising media is attached.

32. A method as claimed in claim 26 and wherein advertising media pole or column may be connected to adaptor via gravitational forces requiring no mechanical fastener.

33. A method as claimed in claim 1 wherein a cap is comprised of a solid or hollow rod which is shorter than the hollow portion of the receiving cylinder and lesser in diameter than the inside diameter of the receiving cylinder having a head attached to one end of the rod preferably larger in diameter than the threaded portion of receiving cylinder and a threaded portion atop of the head allowing for an attachment such as a threaded rod thereby making sleeve easier to locate in fallen leaves or snow covered ground.

34. A method of installing and removing advertising devices such as flags, banners, or similar message conveying means following the steps of:
securing receiving cylinder into stand via mechanical thread
inserting an extension into receiving cylinder to elevate advertising device overcoming such obstacles such as flowerbed, hedges, fences or snow
inserting an adaptor which sits freely atop of receiving portion of extension
connecting adaptor to advertising media, pole or column
inserting a cap which rests freely atop of receiving cylinder or extension thereby restricting contaminants such as dirt and precipitation from entering cylinder or extension after adaptor is removed

35. A method as claimed in 34 wherein the receiving cylinder is comprised of a hollow cylinder having a threaded portion at one end which is secured to a stand via mechanical thread

36. A method as claimed in claim 34 wherein an extension is comprised of a hollow cylindrical rod of the same inside diameter as the receiving cylinder with a solid or hollow rod attached to one end being of a slightly lesser outside diameter than the inside diameter of said receiving cylinder and a collar preferably larger diameter than that of said receiving cylinder which is attached to the circumference of the portion of extension having the smaller diameter thereby limiting the depth the extension may be inserted into the receiving cylinder.

37. A method as claimed in claim 34 wherein an adaptor comprised of a solid or hollow cylindrical rod is smaller in diameter than the inside diameter of the receiving portion of the extension and has a collar nearing the mid portion of the adaptor which is preferably larger in diameter than the receiving portion of the extension thereby limiting the depth in which the adaptor may be inserted into the receiving portion of the extension.

38. A method as claimed in claim 37 and wherein the collar near mid portion of the adaptor has a hole nearing outer portion allowing for the attachment of advertising media, pole or column with appropriate fastener such as elastic, rope, chain or adjustable straps.

39. A method as claimed in claim 34 and whereas a sleeved flag is pulled over the pole and the flag is attached to the adaptor whereby the adaptor keeps the flag from releasing from the top of the pole and in turn the flag prevents the adaptor from releasing from the bottom of the pole which will also create a bend at the top of the pole holding the flag open to view at all times if desired.

40. A method as claimed in claim 37 and wherein adaptor has a bored hole nearing one end to allow attachment of pole or column to which advertising media is attached.

41. A method as claimed in claim 34 and wherein advertising media, pole or column may be connected adaptor via gravitational forces requiring no mechanical fastener.

42. A method as claimed in claim 1 wherein a cap is comprised of a solid or hollow rod which is shorter than the hollow portion of the receiving cylinder and lesser in diameter than the inside diameter of the receiving cylinder having a head attached to one end of the rod preferably larger in diameter than the threaded portion of receiving cylinder and a threaded portion atop of the head allowing for an attachment such as a threaded rod thereby making sleeve easier to locate in fallen leaves or snow covered ground.

43. A method as claimed in claim 4 wherein receiving cylinder has a collar broader in diameter than the cylinder and attached to the circumference of the cylinder nearing end opposite to solid rod and next to threaded portion thereby creating a stopping point acting as a means of limiting depth that the cylinder is inserted beneath the earth's surface.

44. A method as claimed in claim 16 wherein receiving cylinder has a collar broader in diameter than the receiving cylinder and attached to the circumference of the cylinder nearing end opposite to solid rod and next to threaded portion thereby creating a stopping point acting as a means of limiting depth that the cylinder is inserted beneath the earth's surface.
